(19) United States
(12) Patent Application Publication
(10) Pub. No.: US 2017/0125936 A1
(43) Pub. Date: May 4, 2017

(54) RETAINING FRAME FOR PLUG-CONNECTOR MODULES AND/OR PLUG CONNECTORS

(71) Applicant: HARTING Electric GmbH & Co. KG, Espelkamp (DE)

(72) Inventors: Irina Loetkemann, Espelkamp (DE); Bernard Schlegel, Rahden (DE)

(21) Appl. No.: 15/316,087

(22) PCT Filed: May 27, 2015
(86) PCT No.: PCT/DE2015/100210

§ 371 Date: Dec. 2, 2016

(30) Foreign Application Priority Data
Jul. 22, 2014 (DE) 10 2014 110 278.9

(51) Int. Cl. H01R 13/514

(52) U.S. Cl. CPC H01R 13/514

(57) ABSTRACT

The invention relates to a retaining frame for retaining plug-connector modules and/or plug connectors, said retaining frame being provided for incorporation into a plug housing. The retaining frame has a fixing surface and the plug-connector modules and/or the plug connectors are held in the fixing surface. The plug-connector modules and/or the plug connectors can be mounted on different fixing planes (S, M). This allows plug connectors and plug-connector modules with differing mating heights to be installed in a plug-connector housing.

The invention is based on a retaining frame for plug-connector modules and/or plug connectors according to the preamble of independent claim 1.

Retaining frames of this kind are used for fitting different plug-connector modules and different plug connectors to a so-called heavy plug connector. The plug-connector modules usually transmit control signals, while the plug connectors usually transmit high currents (power connectors).

### STATE OF THE ART

EP 0 860 906 B1 shows a retaining frame for plug connector modules. The retaining frame may be incorporated in a plug-connector housing. The modules must all exhibit the same so-called plugging path to the mating connector. This makes it difficult to integrate high-current modules.

### PROBLEM

The problem addressed by the invention is that of proposing a retaining frame that is suitable for a plug connector and is likewise able to transmit control signals and high currents.

The problem is solved by the characterizing features of independent claim 1.

Advantageous embodiments of the invention are specified in the dependent claims.

The retaining frame proposed here is equally suitable for holding plug-connector modules and for holding entire plug connectors. However, only modules or only plug connectors can also be held.

The retaining frame may be incorporated in a plug-connector housing. The retaining frame is usually screwed to the plug-connector housing, in order to guarantee a stable connection of the two parts.

Since the retaining frame can also contain entire plug connectors, one entire (or several) plug connector(s) would be integrated in a higher-level plug-connector housing. The higher-level plug-connector housing is of a corresponding size.

The retaining frame preferably has two side walls and a fixing surface substantially parallel thereto. The plug-connector modules and/or plug connectors are held in the fixing surface.

The fixing surface preferably has two fixing planes which are oriented parallel to one another. The plug-connector modules and/or the plug connectors can be mounted or fixed on the different fixing planes.

In a preferred embodiment, the retaining frame substantially comprises two angular plates and a module carrier, wherein the angular plates are oriented inversely to one another. It could also be said that the angular plates are oriented mirror-symmetrically to one another. The mirror plane is oriented centrally between the angular plates and parallel to a side wall in each case.

The surfaces of the two angular plates spaced apart parallel to one another form the side walls of the retaining frame and the contact surfaces of the angular plates are connected to the module carrier. The contact surfaces along with the module carrier form the fixing surface of the retaining frame.

High plug-in forces often have to be absorbed. The angular plates and module carrier are therefore preferably screwed to one another.

The fixing surface preferably has at least one receiving space for a plug connector, preferably for a power plug connector. Moreover, the fixing surface has at least one receiving space for plug-connector modules, preferably for control modules. In a particularly preferred embodiment, the plug-connector modules and the plug connectors can be mounted on different fixing planes and the fixing plane of the plug-connector modules lies above the fixing plane of the plug connectors. This means that the so-called “mateability”, which can differ greatly in modules and plug connectors, is balanced.

The receiving space for a plug connector is particularly preferably substantially circular and the receiving space for plug-connector modules is substantially rectangular in configuration. The receiving spaces of the plug-connector modules are created by the aforementioned module carrier. The module carrier may contain a plurality of receiving spaces arranged alongside one another.

### EXEMPLARY EMBODIMENT

An exemplary embodiment of the invention is depicted in the drawings and explained in greater detail below. In the figures:

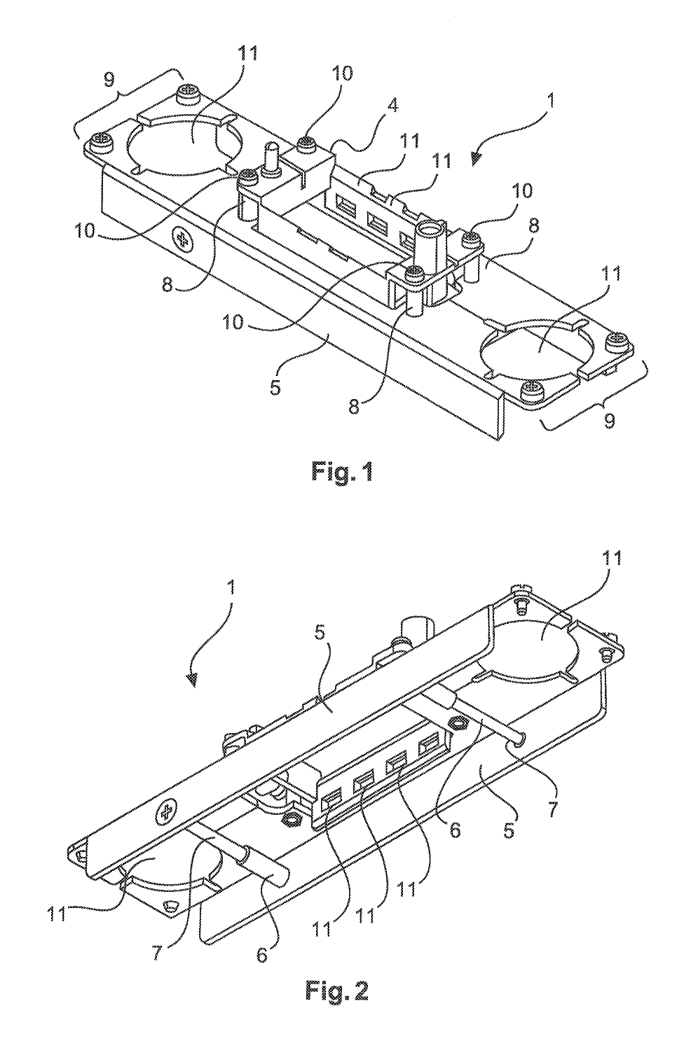

FIG. 1 shows a perspective view of a retaining frame according to the invention,

FIG. 2 shows a further perspective view of the retaining frame,

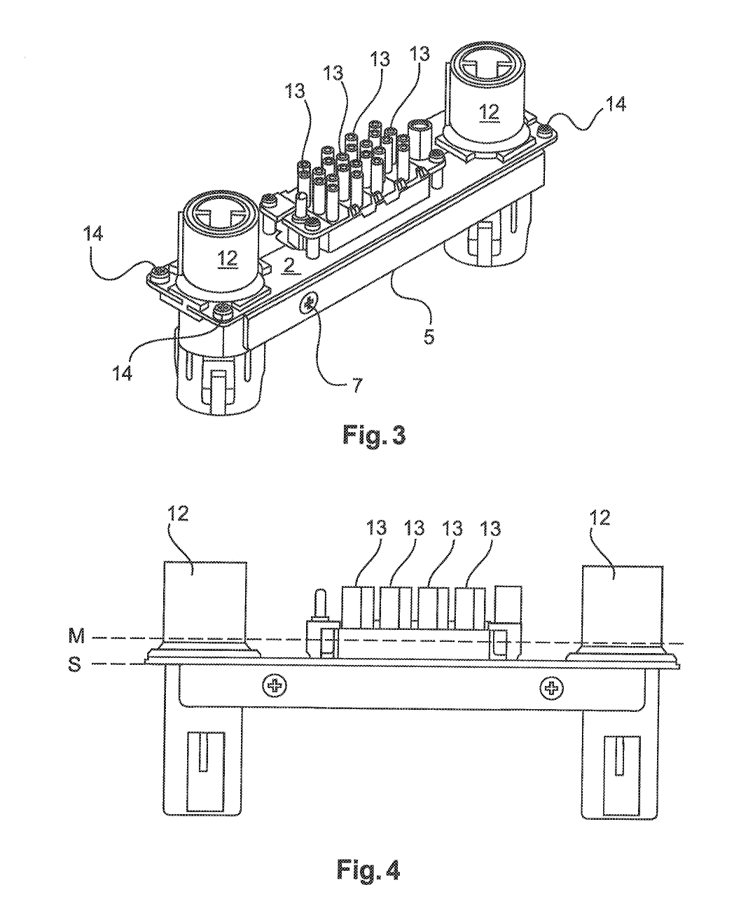

FIG. 3 shows a perspective view of a retaining frame fitted with plug-connector modules and plug connectors and

FIG. 4 shows a side view of the retaining frame fitted with plug connector modules and plug connectors.

The figures contain partially simplified, schematic representations. In some cases, identical reference numbers are used for the same but not identical components, as appropriate. Different views of the same components could be to different scales.

FIG. 1 shows a perspective plan view of a retaining frame according to the invention. The retaining frame substantially comprises two angular plates 2, 3, which are arranged inversely to one another and a module carrier 4 fixed thereon.

The retaining frame 1 has side walls 5. The side walls each have a cylinder body 6 projecting perpendicularly, in which a thread is contained. The cylinder body 6 in each case is oriented to the opposite side wall 5 of the other angular plate 2, 3 in each case. The respective side wall 5 contains a bore which lies opposite the threaded cylinder body 6 of the other angular plate 2, 3 in each case. A screw 7 is guided through the bore and screwed in the thread of the cylinder body 6.

The surfaces of the angular plates 2, 3 abutting one another create the fixing surface 9 of the retaining frame 1. Threaded cylinder bodies 8 project perpendicularly from the fixing surface 9. Via the cylinder body 8, the module carrier 4 is screwed to the angular plates 2, 3 with the help of suitable screws 10.

The module carrier 4 contains recesses 11 through which individual modules can be fixed in the module carrier 4. For the precise mode of operation of the module carrier 4, reference is made to EP 0 860 906 B1, the disclosure content whereof in this regard is contained in this application.

Circular recesses 11 are inserted in the fixing surface 9, which represent receiving means for a plug connector 12. The plug connectors 12 are provided for the transmission of high currents, but they are not further described below.

Individual modules 13 are fixed in the module carrier 4. In the exemplary embodiment shown here, four so-called control modules 13 are located in the module carrier 4. The mode of operation of the modules 13 is not explained in greater detail.

The configuration shown in FIG. 3 comprising a retaining frame 1, plug connector 12 and plug-connector modules 12 is provided to be incorporated in a higher-level, correspondingly large plug-connector housing (not shown). This can be achieved by means of the screws 14.

The different fixing planes of plug-connector modules 13 and plug connectors 12 can be seen in FIG. 4. The plug connectors 12 are fixed within the plane S in the fixing surface 9. The plug-connector modules 13 are located thereabove in the fixing plane M.

Retaining frame for plug-connector modules and/or plug connectors

### LIST OF REFERENCE NUMBERS

1 retaining frame

2 angular plate

3 angular plate

4 module carrier

5 side wall

6 cylinder body

7 screw

8 cylinder body

9 fixing surface

10 screw

11 recess/receiving means

12 plug connector

13 plug-connector module

14 screws

M: plane

S: plane

1. A retaining frame for holding plug-connector modules and/or plug connectors,
wherein the retaining frame has a fixing surface and the plug-connector modules and/or plug connectors are held in the fixing surface
wherein the plug-connector modules and/or the plug connectors can be mounted on different fixing planes.

2. The retaining frame as claimed in claim 1, wherein
the retaining frame substantially comprises two angular plates and a module carrier, wherein the angular plates are oriented inversely to one another,
the surfaces of the two angular plates spaced apart parallel to one another form the side walls of the retaining frame and
the contact surfaces of the angular plates are connected to the module carrier and form the fixing surface of the retaining frame.

3. The retaining frame as claimed in claim 2 wherein
the angular plates and the module carrier are screwed to one another

4. The retaining frame as claimed in claim 1, wherein
the fixing surface has at least one receiving space for a plug connector, preferably a power plug connector.

5. The retaining frame as claimed in claim 1, wherein
the fixing surface has at least one receiving space for plug-connector modules, preferably for control modules.

6. The retaining frame as claimed in claim 1, wherein
the plug-connector modules and the plug connectors can be mounted on different fixing planes (S, M) and
the fixing plane (M) of the plug-connector modules lies above the fixing plane (S) of the plug connectors.

7. The retaining frame as claimed in claim 4, wherein
the receiving space for a plug connector is substantially circular and the receiving space for plug-connector modules is substantially rectangular in configuration.

8. The retaining frame as claimed in claim 1, wherein
the retaining frame is fixed in a plug-connector housing.

9. A system comprising a retaining frame, at least one plug-connector module, a plug connector and a higher-level plug-connector housing.

10. The retaining frame as claimed in claim 5, wherein
the receiving space for a plug connector is substantially circular and the receiving space for plug-connector modules is substantially rectangular in configuration.

11. The retaining frame as claimed in claim 6, wherein
the receiving space for a plug connector is substantially circular and the receiving space for plug-connector modules is substantially rectangular in configuration.
